(19) United States
(12) Patent Application Publication
(10) Pub. No.: US 2025/0370154 A1
(43) Pub. Date: Dec. 4, 2025

(54) SUBSURFACE CONDITION DETECTION USING TUBE WAVES

(71) Applicant: Halliburton Energy Services, Inc., Houston, TX (US)

(72) Inventors: Derek Shelby Bale, Houston, TX (US); Dinesh Ananda Shetty, Houston, TX (US); Yang Yu, Singapore (SG)

(21) Appl. No.: 18/921,650

(22) Filed: Oct. 21, 2024

Related U.S. Application Data
(60) Provisional application No. 63/653,314, filed on May 30, 2024.
(60) Provisional application No. 63/654,764, filed on May 31, 2024.

(51) Int. Cl. G01V 1/50; E21B 49/00

(52) U.S. Cl. CPC G01V 1/50; E21B 49/00

(57) ABSTRACT

A technique for detecting subsurface conditions using tube waves includes receiving a tube wave signal that corresponds to a tube wave within the wellbore. The technique also includes determining one or more categories associated with the tube wave signal. The technique also includes determining an inversion algorithm of a plurality of inversion algorithms based, at least in part, on the one or more categories. The technique also includes using the inversion algorithm of the plurality of algorithms to determine one or more estimates of subsurface conditions.

### BACKGROUND

Hydrocarbons and similar substances may exist in underground deposits and can be extracted by various means, such as drilling wells and using pumps to lift the substance to the surface. Tracking and measuring various aspects of the associated operations is important for maintaining and improving the operations. However, because many of the operations occur far beneath the surface of the earth, it can be difficult to determine the conditions that exist within the well and surrounding formation(s).

### BRIEF DESCRIPTION OF THE DRAWINGS

Embodiments of the disclosure may be better understood by referencing the accompanying drawings.

FIG. 1 is a diagrammatic illustration of an example well system, according to some implementations.

FIG. 2 is an illustration of an example system for training a classifier machine learning module, according to some implementations.

FIG. 3 is an illustration of an example system for training an inversion algorithm selector machine learning module, according to some implementations.

FIG. 4 depicts a system for detecting subsurface conditions using a tube wave, according to some implementations.

FIG. 5 depicts a flow diagram illustrating operations performed to determine one or more estimates of subsurface conditions, according to some implementations.

FIG. 6 depicts a flow diagram illustrating operations performed to use a tube wave signal to generate an alarm or recommendation, according to some implementations.

FIG. 7 depicts a flow diagram illustrating operations performed to train a classifier machine learning module, according to some implementations.

FIG. 8 depicts a flow diagram illustrating operations performed to train an inversion algorithm selector machine learning module, according to some implementations.

FIG. 9 is a block diagram depicting an example computer, according to some implementations.

### DESCRIPTION

The description that follows includes example systems, methods, techniques, and program flows that embody aspects of the disclosure. However, it is understood that this disclosure may be practiced without these specific details. In some instances, well-known instruction instances, protocols, structures, and techniques have not been shown in detail in order not to obfuscate the description.

Because systems used to extract substances (e.g., hydrocarbons) from subsurface formations are located underground, subsurface conditions of the well and related formation can be difficult to monitor. Tube waves (also referred to as “pressure pulses,” “water hammers,” etc.) generated by surface equipment travel down the wellbore and tube wave reflections travel back up to the surface. Tube waves and tube wave reflections (hereinafter “tube waves”) are sensitive to various subsurface conditions, including the borehole's fluid properties, integrity of the borehole wall, and properties of the formation. As such, pressure pulse technology can utilize tube waves to determine the subsurface conditions.

A tube wave can be generated passively or actively. For example, a tube wave may be generated passively when the pumping of fluid through the wellbore is stopped, causing a pressure differential that flows through the well system. As another example, a tube wave may be generated actively when a pressure source, such as an air gun or electrical discharge causes a pressure increase in the hydraulic fluid, resulting in a pressure differential that flows through the well system.

Tube waves are converted into electrical signals using devices such as pressure transducers installed in the well system. Because the tube waves are sensitive to subsurface conditions, which can vary widely, the tube wave signals are complex signals that can be difficult to analyze and use to determine the specific conditions represented by the tube wave signal. In order to make this analysis faster and more useful, various machine learning techniques can be used to classify the tube wave signal and, based on the classification of the tube wave signal, determine an inversion algorithm. The inversion algorithm can be used to determine subsurface conditions or estimations thereof.

In some implementations, two machine learning modules are arranged in a cascading structure. The first machine learning module (hereinafter “classifier machine learning module”) is a feature category classifier that categorizes the tube wave signal into one or more categories. Although categories may vary, some examples of possible categories include “good pressure pulse,” “highly convoluted pressure pulse,” etc.

The second machine learning module (hereinafter “inversion algorithm selector machine learning module”) is an inversion algorithm selector that predicts the optimal inversion algorithm based on the one or more categories determined by the classifier machine learning module. Although the optimal inversion algorithms may vary, some examples of possible inversion algorithms include frequency-based, analytical time-domain, and numerical time-domain, etc.

In some implementations, the classifier machine learning module is trained on tube wave signals that have been labelled manually or using an algorithm such as a single-value decomposition or a principal component analysis-based classifier. The training data can also include a variety of other data, including operational parameters (e.g., amplitude of a pumping fluid rate drop), wellbore design parameters (e.g., frack fluid density), and completion design parameters (e.g., stage depth and number of perforations).

In some implementations, the inversion algorithm selector machine learning module is trained on data that indicates how well inversion algorithms performed for different categories of tube wave signals. The inversion process includes having a forward model that describes physics of the wellbore described via suitable governing equations and solving for an unknown of the fracturing process, by repeatedly varying the value of the unknown variable until the tube wave signal generated from the forward model matches the measured tube wave. The governing equations can have many different simplifications or different numerical procedures to solve the system, leading to many different inversion algorithms of different complexities. With the predicted and measured tube waves a quality of fitness can be obtained which measures the discrepancy between the measured and predicted tube waves. Also, the time required to perform the computation can be measured as another metric. A combination of these metrics can be created using different weights. The training data can also include the training data used for the classifier machine learning module (e.g., operational, wellbore design, and completion parameters) or additional data not used for training the classifier machine learning module.

Once the machine learning modules have been trained, the machine learning modules can be utilized to generate subsurface conditions or estimations thereof. In some implementations, a tube wave is generated by surface and/or downhole equipment, such as a pump, valve, or any other type of pressure excitation source. The tube wave is transformed into a tube wave signal and used as input to the classifier machine learning module, along with any relevant data (e.g., operational parameters, wellbore design parameters, completion parameters, etc.). The classifier machine learning module outputs one or more categories based on the input data. The one or more categories are used as input to the inversion algorithm selector machine learning module along with any relevant data (e.g., operational parameters, wellbore design parameters, completion parameters, etc.).

The inversion algorithm selector machine learning module determines an appropriate inversion algorithm to use for the tube wave signal. Once the inversion algorithm is determined, the inversion algorithm can be used to determine subsurface conditions (or estimations thereof) by applying the inversion algorithm to the tube wave signal. Examples of subsurface conditions include wellbore properties, hydraulic fracturing fluid properties, well completion properties, fracture properties, and reservoir properties.

The classifier machine learning module can be expressed by Equation 1, where p is an instance of a tube wave signal:

$${y}_{1} = classifier\_function ( p ) \qquad Equation 1$$

y₁ is a label vector representing the categories applied to p. The label vector is a set of one or more binary values that represents whether the input instance has the i-th label (category).

The classifier machine learning module is a multi-label classifier, thus allowing a particular tube wave signal to have one or more categories. For example, a particular tube wave signal p may be labelled by the classifier machine learning module with the categories “strong,” “convoluted,” and “large decay.”

The inversion algorithm selector machine learning module can be expressed by Equation 2, where y₁ is a label vector representing the categories of a given tube wave signal:

$${y}_{2} = algorithm\_select \_function ( y 1 ) \qquad Equation 2$$

y₂ is the index corresponding to the selected inversion algorithm to be used for determining subsurface conditions. If y₂=j, then the j-th inversion algorithm should be used for the tube wave associated with y₁.

Although many different algorithms may be used, an example inversion algorithm may be finding the minimum discrepancy between a raw tube wave signal and a forward model using time domain data that simulates pressure waves under different subsurface parameters θ and may be represented by Equation 3:

$$θ = arg min loss\_function ( \hat{p} ( θ , {y}_{2} ) , p ) \qquad Equation 3$$

In Equation 3, \hat{p} (θ, y₂) represents the predicted pressure waves from the forward model with the inversion algorithm index y₂ and θ represents unknown subsurface parameters.

In some implementations, the loss function of Equation 3 may include the sum of absolute errors (i.e., L1 norm), sum of squared errors (i.e., L2 norm), or the Pearson correlation coefficient.

In some implementations, a tube wave may be generated by changing the flow rate of at least one pump, neutralizing all of the pumps, opening or closing at least one of the surface valves, etc.

In some implementations, the classifier machine learning module may contain at least one time-frequency analysis module, including Short-Time Fourier Transform, Wavelet Transform, Hilbert-Huang Transform, etc., that is usable to predict the category of a tube wave.

The loss function for training the classifier machine learning module may be defined by Equation 4:

$${Loss}_{module 1} = {‖ classifier\_function ( p ) - {y}_{1}^{*} ‖}_{2}^{2} \qquad Equation 4$$

In some implementations, the desired feature class y*₁ can be generated based on a historical database via manual labeling or a rule-based approach that uses statistical and spectrum information associated with the tube wave.

The loss function for training the inversion algorithm selector machine learning module may be defined by Equation 5:

$${Loss}_{module 2} = {‖ algorithm\_select \_function ( {y}_{1} ) - {y}_{1}^{*} ‖}_{2}^{2} \qquad Equation 5$$

$${y}_{2}^{*} = arg min loss\_function ( \hat{p} ( θ , {y}_{2} ) , p )$$

In some implementations, the desired y*₂ can be generated by selecting the inversion algorithm that gives the fit with the minimum deviation between instances of raw tube wave signals and predicted tube wave signals across all available inversion algorithms.

In some implementations, the loss function for the inversion algorithm selector machine learning module may include the computation time of the inversion algorithm. By including the computation time of the inversion algorithm in the loss function, the fitting performance can be balanced with computation time. Balancing the fitting performance with the computation time of the inversion algorithm can, for example, help prevent scenarios where the inversion algorithm selector machine learning module selects an inversion algorithm that has fractionally better fitting performance but takes magnitudes longer than the inversion algorithm with the next best fitting performance.

In some implementations, the inversion algorithm selected by the inversion algorithm selector machine learning module contains one or more combinations of forward models (e.g., frequency-domain model, analytical time-domain model, numerical time-domain model, etc.) and loss functions (e.g., L1 norm, L2 norm, Pearson correlation coefficient, etc.).

In some implementations, an alarm or recommendation can be activated if the classifier machine learning module categorizes the tube wave signal as having at least one of a set of pre-determined categories. For example, if the classifier machine learning module determines that the tube wave signal is “weak” or “convoluted,” a recommendation may be made. For example, if it is determined that a tube wave signal indicates a weak tube wave, a recommendation to generate a second tube wave by a pump using a higher initial pumping rate may be generated. As another example, if it is determined that a tube wave signal indicates a convoluted tube wave, then a recommendation to leave more idle time between each ramp down procedure at the end of the stage may be made.

In some implementations, alarms and/or recommendations triggered by pre-determined categories from the classifier machine learning module may automatically modify or update a downhole operation or attribute. For example, an operation (at the surface or downhole) may be performed and/or directed to be performed to change a downhole operation or attribute based on whether the tube wave signal is categorized as being one or more category of a set of pre-determined categories. For example, if the tube wave signal is classified as “weak,” a pressure excitation source may be triggered in a manner that generates a stronger tube wave. As another example, if the tube wave signal is classified as “convoluted,” a delay period setting may be increased in order to prevent ramp down procedures from occurring too soon after each other.

At least one of the inversion algorithms may be a time-domain analytical forward model. Examples of time-domain analytical forward models include numerical models simulating transient fluid dynamics and analytical models describing transient fluid dynamics based on the Joukowsky equation and wave equations describing pressure pulse propagation and reflection.

In some implementations, a downhole operation or attribute in the wellbore may be started, modified, or updated based on determining one or more subsurface conditions of a well system. For example, an operation (at the surface or downhole) may be performed and/or directed to be performed to change a downhole operation or attribute based on the efficiency of the well system. An example of one or more downhole operations that might be performed in response to determining one or more subsurface conditions are downhole operations to add additional perforations or lodge a diverter to a stage, etc. Similarly, attributes of the operations in the wellbore may be set based on determining the efficiency of the well system. Examples of such attributes of the operations may include composition of the fluid, proppant concentration, injection rate, etc

### Example Systems

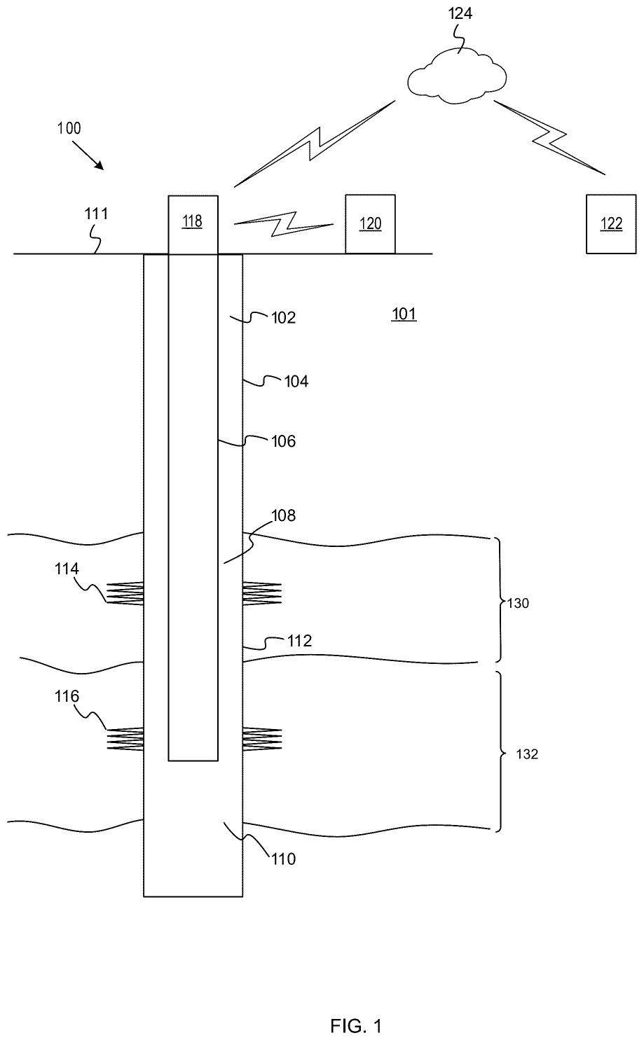

FIG. 1 is a diagrammatic illustration of an example well system, according to some implementations. In particular, FIG. 1 depicts a well system 100 that includes a wellbore 102 in a formation 101. The wellbore 102 includes a casing 104 and a number of perforations 114, 116 in the casing 104. Each set of perforations 114, 116 is made in a corresponding stage of a set of stages 130 and 132 to allow reservoir fluids (i.e., oil, water, and gas) from the formation 101 to flow into the wellbore 102 and into the tubular string 106 (the production tubing).

The well system 100 includes a wellhead 118 located on a pad 111. The pad 111 may include a variety of equipment that varies depending on the stage of the operation, some of which may be part of the wellhead 118. For the purposes of the discussion herein, the pad 111 includes a pump (not depicted) that injects fluid and other substances into the wellbore 102, or other component capable of creating a tube wave (pressure excitation source). The well system 100 also includes one or more computing systems, illustrated as computing system A 120 and computing system B 122. Computing system A 120 and computing system B 122 are communicatively coupled with one or more components of the well system 100. Computing system A 120 is located on the pad 111 while computing system B 122 is located at a different location off the pad 111 and is communicatively coupled via network 124.

In operation, the pressure excitation source generates a tube wave. The tube wave travels through the wellbore 102 (e.g., through the fluid located in the wellbore 102, the tubular string 106, etc.). The tube wave interacts with the components of the wellbore 102, the formation 101, etc. and produces reflected waves that travel back up to the wellhead 118. The wellhead 118 and/or the pad 111 include equipment configured to measure the tube wave and transform it into a tube wave signal, such as a pressure transducer (not depicted).

The tube wave signal can be transmitted to one or more computing systems, such as computing system A 120 and computing system B 122. The computing system(s) can capture, process, and store the tube wave signal. The computing systems(s) may also use the tube wave signal to determine subsurface conditions of the wellbore 102 as described herein.

Although computing system A 120 and computing system B 122 are depicted as being communicatively coupled with components of the well system 100, some implementations may not have a computing system communicatively coupled to the components of the well system 100 and instead may have the tube wave signal transferred via machine-readable storage media, such as a flash drive.

FIG. 1 depicts two computing systems (computing system A 120 and computing system B 122) to demonstrate that computing systems may be located on or off the pad 111. Actual implementations may have one or more computing systems located on or off the pad 111.

### Example Computing Systems

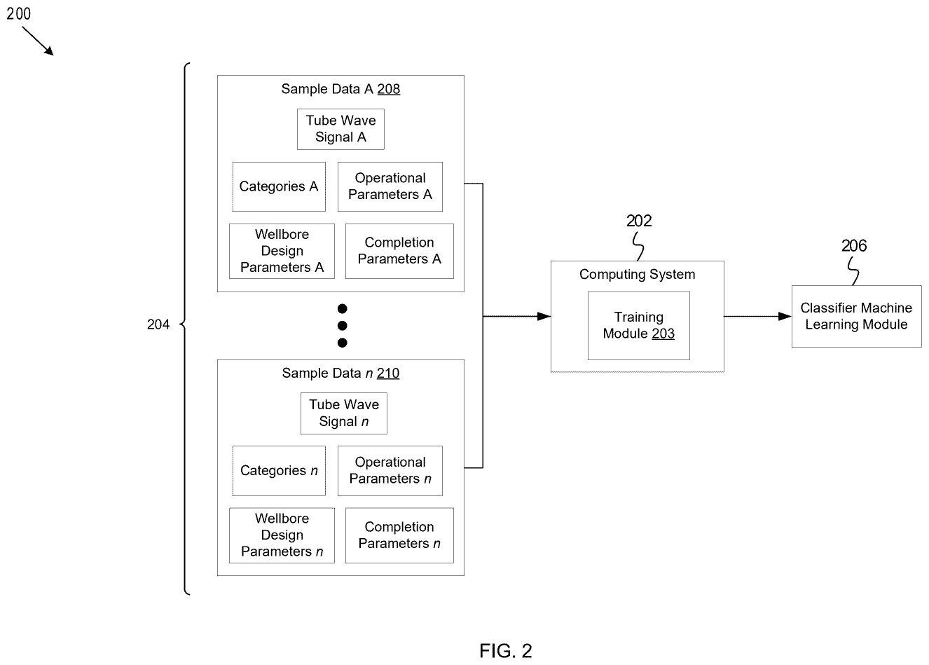

FIG. 2 is an illustration of an example system for training a classifier machine learning module, according to some implementations. In particular, FIG. 2 depicts an example system 200 including a computing system 202, training data 204, and a classifier machine learning module 206. The computing system 202 includes a training module 203. The training data 204 consists of sets of samples data A through n (represented by sample data A 208 and sample data n 210). The classifier machine learning module 206 can implement the functionality of the classifier machine learning module as described above.

Each set of sample data includes a tube wave signal and data associated with the tube wave signal. For example, sample data A 208 includes tube wave signal A and associated data, specifically: categories A, operational parameters A, wellbore design parameters A, and completion parameters A. Each set of associated data in sample data A 208 (e.g., categories A), is related to tube wave signal A in some way. For example, categories A may be categories assigned to the tube wave signal A by a manual or automated labelling process. Similarly, operational parameters A, wellbore design parameters A, and completion parameters A may be the operational parameters, wellbore design parameters, and completion parameters associated with the well system in which the tube wave signal A was generated. The same relationships apply within each sample of the training data 204. For example, the sample data n 210 includes a tube wave signal n, categories n, operational parameters n, wellbore design parameters n, and completion parameters n. Each of the data in sample data n 210 is associated with tube wave signal n.

The training data 204 is provided as input to the training module 203 and training is initiated. The training module may use any applicable techniques for training a machine learning module capable of performing the classification operations described herein.

Once training is complete, the training module 203 outputs the classifier machine learning module 206. The classifier machine learning module 206 can contain one or more machine learning models and related code usable to perform the classification operations described herein.

Although not required, the classifier machine learning module 206 is typically persisted to a machine-readable storage medium, such as a hard drive or an object store in the cloud.

While FIG. 2 includes examples of potential training data (e.g., operational parameters, wellbore design parameters, and completion parameters), the depicted data is not required. For example, in some implementations, a tube wave signal and associated categories may be the only data provided. In some other implementations, additional data not described here may be used. Further, training the classifier machine learning module 206 may be an iterative process and different data may be used for different iterations.

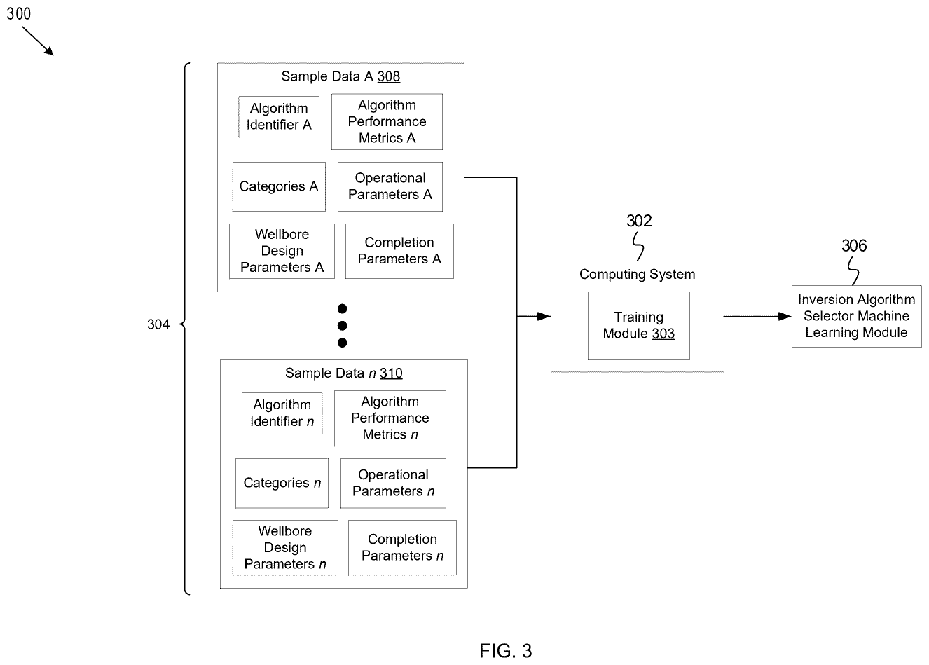

FIG. 3 is an illustration of an example system for training an inversion algorithm selector machine learning module, according to some implementations. In particular, FIG. 3 depicts an example system 300 including a computing system 302, training data 304, and an inversion algorithm selector machine learning module 306. The computing system 302 includes a training module 303. The training data 304 consists of sets of samples data A through n (represented by sample data A 308 and sample data n 310). The inversion algorithm selector machine learning module 306 can implement the functionality of the inversion algorithm selector machine learning module as described above.

Each set of sample data includes an algorithm identifier, at least one algorithm performance metric, and at least one category. For example, sample data A 308 includes algorithm identifier A and associated data, specifically: algorithm performance metrics A, categories A, operational parameters A, wellbore design parameters A, and completion parameters A. Each set of associated data in sample data A 308 (e.g., categories A), is related to a particular instance of a tube wave signal in some way. For example, categories A may be categories assigned to the tube wave signal A by a manual or automated labelling process, or by using a classifier machine learning module to determine the categories (e.g., classifier machine learning module 206). Similarly, operational parameters A, wellbore design parameters A, and completion parameters A may be the operational parameters, wellbore design parameters, and completion parameters associated with the well system in which the particular tube wave signal was generated. The same relationships apply within each sample of the training data 304. For example, the sample data n 310 includes an algorithm identifier n, algorithm performance metrics n, categories n, operational parameters n, wellbore design parameters n, and completion parameters n. Each of the data in sample data n 310 is associated with a particular tube wave signal.

The training data 304 generally consists of data that shows how well a particular inversion algorithm performed (the algorithm performance metrics) when applied to a tube wave signal having particular characteristics (the categories) under particular conditions (the operational, wellbore design, and completion parameters). One technique for generating the target data for training 304 includes executing each available inversion algorithm against all tube wave signals in a database of tube wave signals and storing the algorithm performance metrics for each combination of tube wave signal and inversion algorithm. The training data includes features such as classification label, tube wave, well geometrical detail, fluid properties etc. The target data includes inversion algorithm and performance metric for each inversion algorithm. For each combination, the algorithm identifier, algorithm performance metrics, and associated data can be stored and used as a sample of the training data 304.

The training data 304 is provided as input to the training module 303 and training is initiated. The training module may use any applicable techniques for training a machine learning module capable of performing the inversion algorithm selection operations described herein.

Once training is complete, the training module 303 outputs the inversion algorithm selector machine learning module 306. The inversion algorithm selector machine learning module 306 can contain one or more machine learning models and related code usable to perform the classification operations described herein.

Although not required, the inversion algorithm selector machine learning module 306 is typically persisted to a machine-readable storage medium, such as a hard drive or an object store in the cloud.

While FIG. 3 includes examples of potential training data (e.g., operational parameters, wellbore design parameters, and completion parameters), the depicted data is not required. For example, in some implementations, an algorithm identifier, algorithm performance metrics, and associated categories may be the only data provided. In some other implementations, additional data not described here may be used. Further, training the inversion algorithm selector machine learning module 306 may be an iterative process and different data may be used for different iterations.

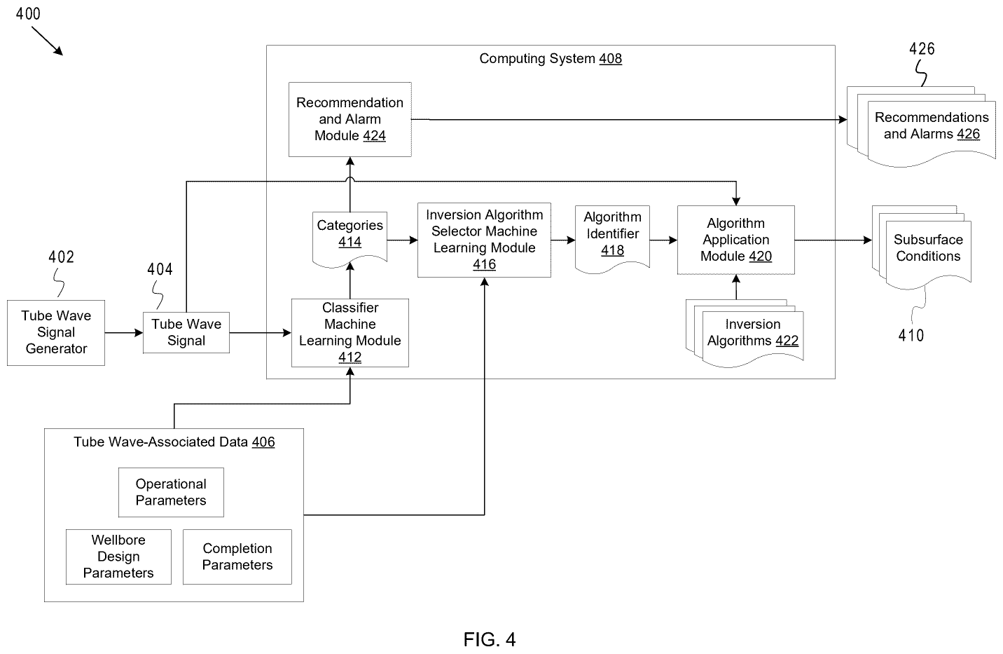

FIG. 4 depicts a system for detecting subsurface conditions using a tube wave, according to some implementations. In particular, FIG. 4 depicts a system 400 comprising a tube wave signal generator 402, a tube wave signal 404, tube wave-associated data 406, and computing system 408. The computing system 408 may output subsurface conditions 410 and recommendations and alarms 426. The computing system 408 comprises a classifier machine learning module 412, an inversion algorithm selector machine learning module 416, an algorithm application module 420, and a recommendation and alarm module 424.

In operation, the tube wave signal generator 402 generated the tube wave signal 404. For example, the tube wave signal generator 402 may be a pressure transducer installed in the well system 100 (e.g., in the wellhead 118 or the wellbore 102) of FIG. 1. The pressure transducer may register fluctuations in the pressure of fluid within the wellbore 102 and transform those pressure fluctuations into an electrical signal representing the pressure fluctuations of the tube wave, which becomes the tube wave signal 404.

The classifier machine learning module 412 receives the tube wave signal 404. The classifier machine learning module 412 can receive the tube wave signal 404 via a push mechanism (e.g., the tube wave signal generator 402 or other component sends the tube wave signal 404 to the computing system 408) or a pull mechanism (e.g., the classifier machine learning module 412 reads the tube wave signal 404 from a data store).

The classifier machine learning module 412 receives the tube wave-associated data 406. The classifier machine learning module 412 can receive the tube wave-associated data 406 via a push mechanism (e.g., another component sends the tube wave-associated data 406 to the computing system 408) or a pull mechanism (e.g., the classifier machine learning module 412 reads the tube wave-associated data 406 from a data store).

The classifier machine learning module 412 determines the categories 414 based, at least in part, on the tube wave signal 404 and the tube wave-associated data 406. The categories 414 are one or more categories that the classifier machine learning module 412 determines apply to the tube wave signal 404.

The inversion algorithm selector machine learning module 416 receives the categories 414 and the tube wave-associated data 406. The inversion algorithm selector machine learning module 416 determines based, at least in part, on the categories 414 and the tube wave-associated data 406, the algorithm identifier associated with an inversion algorithm of the inversion algorithms 422. In other words, the inversion algorithm selector machine learning module 416 selects an inversion algorithm of the inversion algorithms 422 based on the categories 414 and the conditions associated with the tube wave that corresponds to the tube wave signal 404, where the conditions are represented by the tube wave-associated data 406.

Typically, the inversion algorithm selector machine learning module 416 determines the “best” inversion algorithm of the inversion algorithms 422, but the definition of “best” may vary depending on various goals. For example, in some implementations the inversion algorithm selector machine learning module 416 may select an inversion algorithm that produces the most accurate subsurface conditions 410, but in other implementations the inversion algorithm selector machine learning module 416 may balance the accuracy of the subsurface conditions 410 with the computational performance of the inversion algorithm.

The algorithm application module 420 receives the algorithm identifier 418 and selects the corresponding inversion algorithm from the inversion algorithms 422. The algorithm application module then applies the inversion algorithm to the tube wave signal 404 to get the subsurface conditions 410 (or estimates thereof).

In some implementations, the recommendation and alarm module 424 also receives the categories 414. The recommendation and alarm module 424 then determines whether one or more of the categories 414 is in a predefined set of categories and, if so, generates one or more recommendations and alarms 426.

As with the training operations described above, the specific tube wave-associated data 406 described here (operational, wellbore design, and completion parameters) may not be used in some implementations. Further, some implementations may use different data which may or may not be associated with the specific tube wave that is being analyzed.

Although computing system 408 is depicted as including each of the modules, some implementations may have one or more of the modules split out and operated on other computing systems 408.

### Example Operations

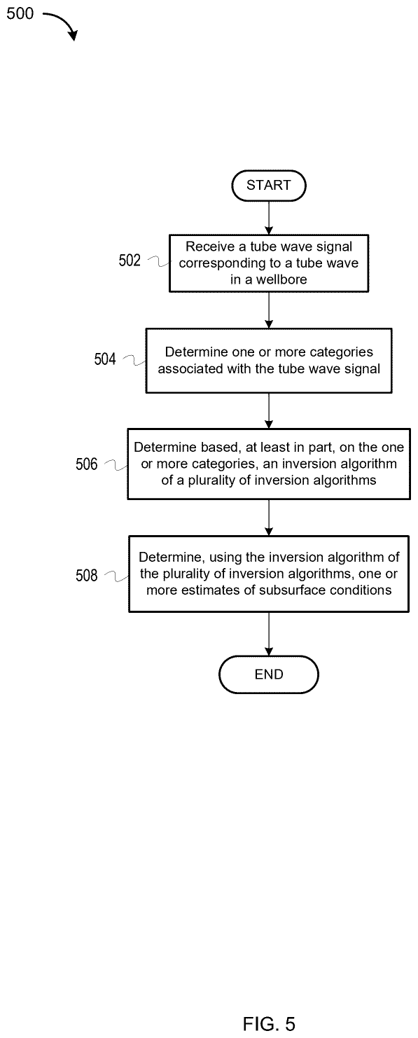

FIG. 5 depicts a flow diagram illustrating operations performed to determine one or more estimates of subsurface conditions, according to some implementations. Operations depicted in the flowchart 500 of FIG. 5 can be performed by one or more machines, one or more computing systems (e.g., computing system 408 of FIG. 4), software, firmware, hardware, or any combination thereof. The operations of flowchart 500 may be described in reference to implementations described herein but the operations can be adapted to work with any suitable implementation. Operations of flowchart 500 start at block 502.

At block 502, a tube wave signal corresponding to a tube wave in a wellbore is received. For example, the computing system 408 in FIG. 4 receives the tube wave signal 404 from the tube wave signal generator 402.

At block 504, one or more categories associated with the tube wave signal are determined. The categories can be determined by a machine learning module, such as the classifier machine learning module 412 in FIG. 4, or any suitable mechanism.

At block 506, an inversion algorithm of a plurality of inversion algorithms is determined based, at least in part, on the one or more categories. The inversion algorithm of a plurality of inversion algorithms may be determined by a machine learning module, such as the inversion algorithm selector machine learning module 416 in FIG. 4, or any suitable mechanism.

At block 508, one or more estimates of subsurface conditions are determined by applying the inversion algorithm of the plurality of inversion algorithms to the tube wave signal. The one or more estimates of subsurface conditions can be determined by an algorithm application module, such as the algorithm application module 420 of FIG. 4, or any suitable mechanism.

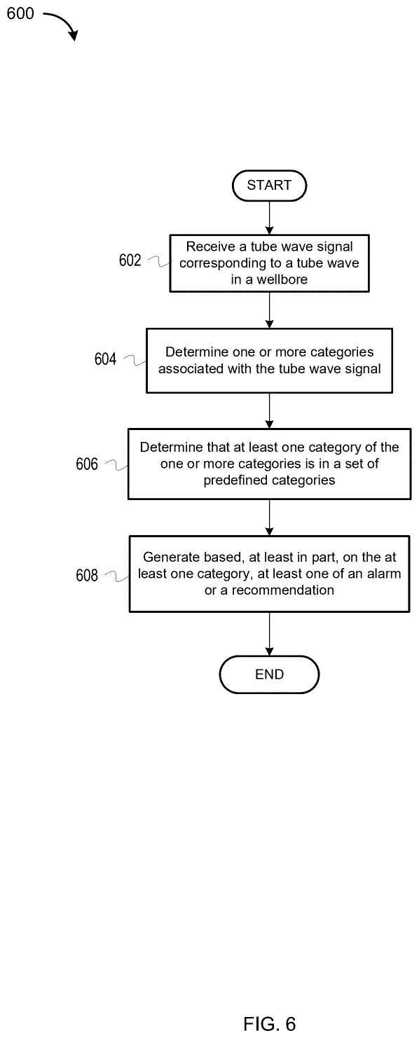

FIG. 6 depicts a flow diagram illustrating operations performed to use a tube wave signal to generate an alarm or recommendation, according to some implementations. Operations depicted in the flowchart 600 of FIG. 6 can be performed by one or more machines, one or more computing systems (e.g., computing system 408 of FIG. 4), software, firmware, hardware, or any combination thereof. The operations of flowchart 600 may be described in reference to implementations described herein but the operations can be adapted to work with any suitable implementation. Operations of flowchart 600 start at block 602.

At block 602, a tube wave signal corresponding to a tube wave in a wellbore is received. For example, the computing system 408 in FIG. 4 receives the tube wave signal 404 from the tube wave signal generator 402.

At block 604, one or more categories associated with the tube wave signal are determined. The categories can be determined by a machine learning module, such as the classifier machine learning module 412 in FIG. 4, or any suitable mechanism.

At block 606, it is determined that at least one category of the one or more categories is in a set of predefined categories. Whether at least one category of the one or more categories is in a set of predefined categories can be determined by a recommendation and alarm module, such as recommendation and alarm module 424 in FIG. 4, or any suitable mechanism.

At block 608, at least one of an alarm or a recommendation is generated based, at least in part, on the at least one category. The alarm or recommendation can be generated by a recommendation and alarm module, such as recommendation and alarm module 424 in FIG. 4, or any suitable mechanism.

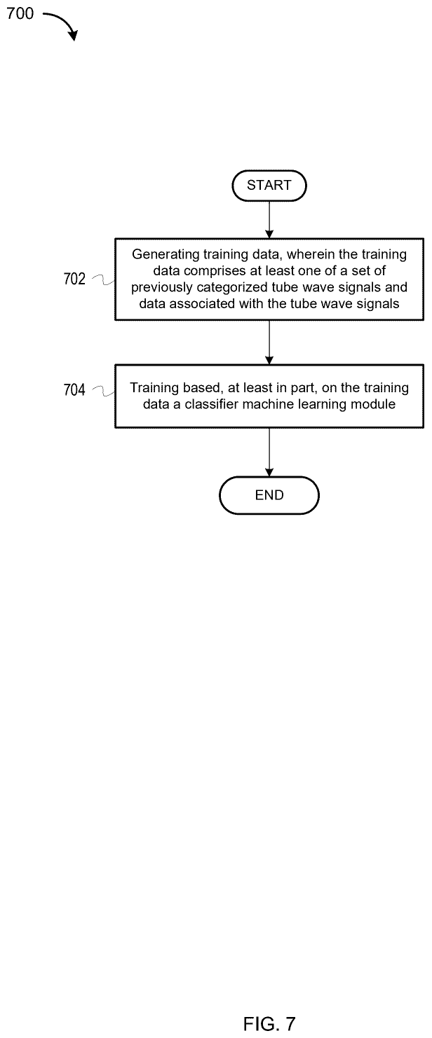

FIG. 7 depicts a flow diagram illustrating operations performed to train a classifier machine learning module, according to some implementations. Operations depicted in the flowchart 700 of FIG. 7 can be performed by one or more machines, one or more computing systems (e.g., the computing system 202 of FIG. 2), software, firmware, hardware, or any combination thereof. The operations of flowchart 700 may be described in reference to implementations described herein but the operations can be adapted to work with any suitable implementation. Operations of flowchart 700 start at block 702.

At block 702, training data is generated. The training data may comprise at least one of a set of previously categorized tube wave signals and data associated with the tube wave signals. The training data may be generated by any suitable computing system, such as computing system 202 of FIG. 2.

At block 704, a classifier machine learning module may be trained based, at least in part, on the training data. The classifier learning module may be trained by any suitable computing system, such as computing system 202 of FIG. 2.

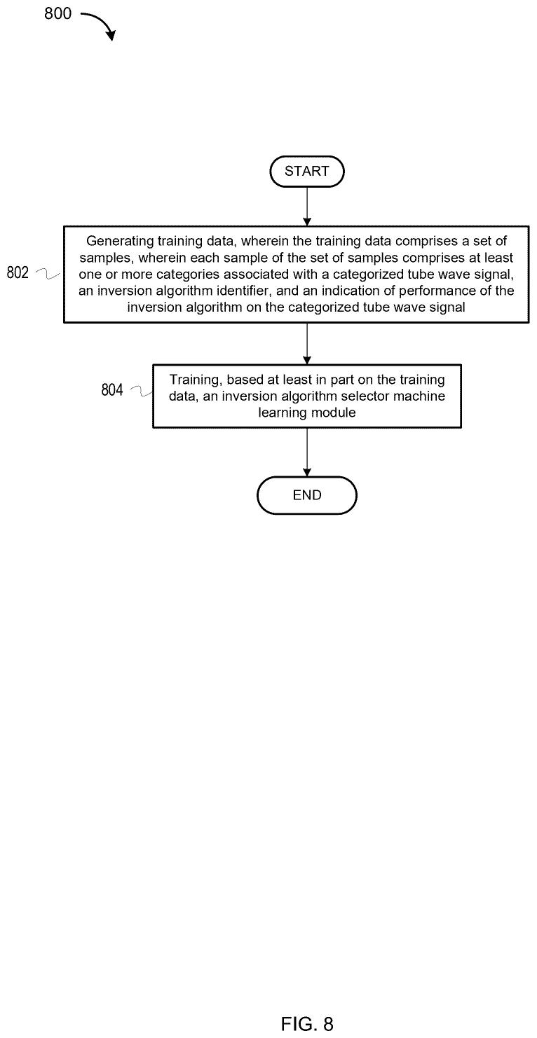

FIG. 8 depicts a flow diagram illustrating operations performed to train an inversion algorithm selector machine learning module, according to some implementations. Operations depicted in the flowchart 800 of FIG. 8 can be performed by one or more machines, one or more computing systems (e.g., the computing system 302 of FIG. 3), software, firmware, hardware, or any combination thereof. The operations of flowchart 800 may be described in reference to implementations described herein but the operations can be adapted to work with any suitable implementation. Operations of flowchart 800 start at block 802.

At block 802, training data is generated. The training data may comprise a set of samples where each sample of the set of samples comprises at least one or more categories associated with a categorized tube wave signal, an inversion algorithm identifier, and an indication of performance of the inversion algorithm on the categorized tube wave signal. The training data may be generated by any suitable computing systems, such as computing system 302 of FIG. 3.

At block 804, an inversion algorithm selector machine learning module is trained based, at least in part, on the training data. The inversion algorithm selector machine learning module may be trained by a suitable computing system, such as computing system 302 of FIG. 3.

For the purposes of the descriptions herein, it is understood that machine learning processes typically produce probabilities. As such, when describing a machine learning process as “determining x,” it is understood that the machine learning process may be determining the probability of x, determining that the probability of x is over a particular threshold, etc. Thus, for example, the phrase “determine one or more categories associated with a tube wave signal” is meant to encompass an estimation or probability that the tube wave signal is associated with the determined categories.

While the aspects of the disclosure are described with reference to various implementations and exploitations, it will be understood that these aspects are illustrative and that the scope of the claims is not limited to them. In general, techniques for detecting subsurface conditions using tube waves as described herein may be implemented with facilities consistent with any hardware system or hardware systems. Many variations, modifications, additions, and improvements are possible.

Plural instances may be provided for components, operations or structures described herein as a single instance. Further, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

### Example Computer

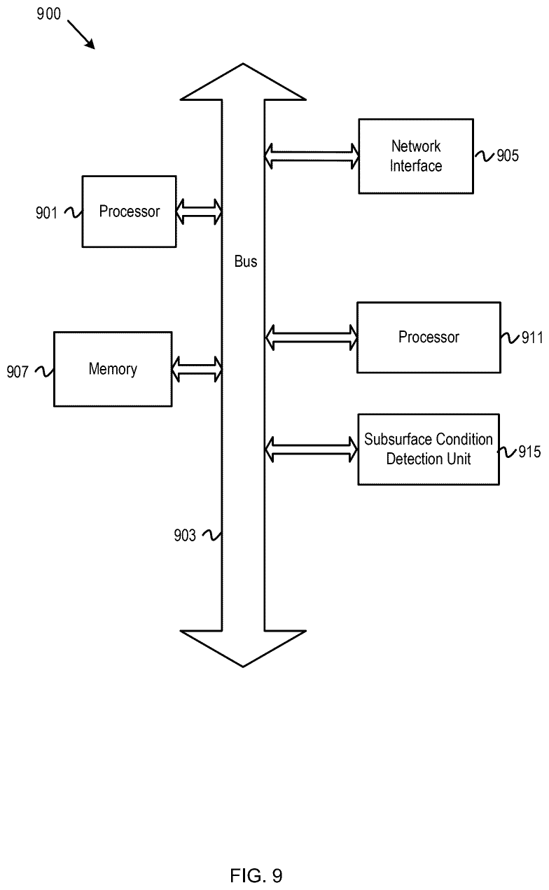

FIG. 9 is a block diagram depicting an example computer, according to some implementations. FIG. 9 depicts a computer 900 for detecting subsurface conditions using tube waves. The computer 900 includes a processor 901 (possibly including multiple processors, multiple cores, multiple nodes, and/or implementing multi-threading, etc.). The computer 900 also includes a subsurface condition detection unit 915 which may perform the operations described herein. For example, the subsurface condition detection unit 915 may receive a tube wave signal corresponding to a tube wave in a wellbore; determine one or more categories associated with the tube wave signal; determine based, at least in part, on the one or more categories, an inversion algorithm of a plurality of inversion algorithms; and determine, using the inversion algorithm of the plurality of inversion algorithms, one or more estimates of subsurface conditions. Any one of the previously described functionalities may be partially (or entirely) implemented in hardware and/or on subsurface condition detection unit 915. For example, the functionality may be implemented with an application specific integrated circuit, in logic implemented in the subsurface condition detection unit 915, in a co-processor on a peripheral device or card, etc. Further, realizations may include fewer or additional components not illustrated in FIG. 9 (e.g., video cards, audio cards, additional network interfaces, peripheral devices, etc.). The processor 901 and the network interface 905 are coupled to the bus 903. Although illustrated as being coupled to the bus 903, the memory 907 may be coupled to the processor 901. The computer 900 includes memory 907. The memory 907 may be system memory or any one or more possible realizations of machine-readable media. The computer 900 can communicate via transmissions to and/or from remote devices via the network interface 905 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

### Example Implementations

Implementation 1: A method for determining subsurface conditions in a wellbore, the method comprising: receiving a tube wave signal corresponding to a tube wave within the wellbore; determining one or more categories associated with the tube wave signal; determining, based at least in part on the one or more categories, an inversion algorithm of a plurality of inversion algorithms; and determining, using the inversion algorithm of the plurality of inversion algorithms, one or more estimates of subsurface conditions.

Implementation 2: The method of Implementation 1, further comprising training a machine learning module on a set of training data, wherein the training data comprises at least a set of previously categorized tube wave signals, wherein said determining the one or more categories associated with the tube wave signal is performed by the machine learning module.

Implementation 3: The method according to any of the above preceding Implementations, wherein the training data further comprises at least one of operational parameters, wellbore design parameters, or completion parameters.

Implementation 4: The method according to any of the preceding Implementations, further comprising generating the set of previously categorized tube wave signals using a classifier module.

Implementation 5: The method according to any of the preceding Implementations, further comprising training a machine learning module on a set of training data, wherein the training data comprises a set of combinations, the combinations comprising one or more categories associated with a categorized tube wave signal, an indication of an inversion algorithm of the plurality of inversion algorithms, and an indication of a performance of the inversion algorithm on the categorized tube wave signal, wherein said determining the inversion algorithm of the plurality of inversion algorithms is performed by the machine learning module.

Implementation 6: The method according to any of the preceding Implementations, wherein the training data further comprises at least one of operational parameters, wellbore design parameters, or completion parameters.

Implementation 7: The method according to any of the preceding Implementations, further comprising: determining that at least one category of the one or more categories is in a predefined set of categories; and in response to said determining that the at least one category of the one or more categories is in the predefined set of categories, generate an indication of a subsurface condition.

Implementation 8: The method according to any of the preceding Implementations, further comprising: generating the tube wave in the wellbore; and transforming the tube wave into the tube wave signal.

Implementation 9: A well system comprising: a computing system comprising: one or more processors; and one or more non-transitory computer-readable mediums including instructions which, when executed by the one or more processors, cause the one or more processors to determine subsurface conditions in a wellbore, the instructions including: instructions to receive a tube wave signal corresponding to a tube wave within the wellbore; instructions to determine one or more categories associated with the tube wave signal; instructions to determine, based at least in part on the one or more categories, an inversion algorithm of a plurality of inversion algorithms; and instructions to determine, using the inversion algorithm of the plurality of inversion algorithms, one or more estimates of subsurface conditions.

Implementation 10: The well system of Implementation 9, the instructions further including instructions to train a machine learning module on a set of training data, wherein the training data comprises at least a set of previously categorized tube wave signals, wherein said instructions to determine one or more categories associated with the tube wave signal are included in the machine learning module.

Implementation 11: The well system according to any of the preceding Implementations, wherein the training data further comprises at least one of operational parameters, wellbore design parameters, or completion parameters.

Implementation 12: The well system according to any of the preceding Implementations, the instructions further including instructions to train a machine learning module on a set of training data, wherein the training data comprises a set of combinations, the combinations comprising one or more categories associated with a categorized tube wave signal, an indication of an inversion algorithm of the plurality of inversion algorithms, and an indication of a performance of the inversion algorithm on the categorized tube wave signal, wherein the instructions to determine the inversion algorithm of the plurality of inversion algorithms are included in the machine learning module.

Implementation 13: The well system according to any of the preceding Implementations, wherein the training data further comprises at least one of operational parameters, wellbore design parameters, or completion parameters.

Implementation 14: The well system according to any of the preceding Implementations, further comprising: a pressure excitation device configured to generate the tube wave in the well system; and a device communicatively coupled with the computing system, the device configured to transform the tube wave into the tube wave signal and transmit the tube wave signal to the computing system.

Implementation 15: One or more non-transitory computer-readable mediums including instructions which, when executed by a processor, cause the processor to determine subsurface conditions in a wellbore, the instructions comprising: instructions to receive a tube wave signal corresponding to a tube wave within the wellbore; instructions to determine one or more categories associated with the tube wave signal; instructions to determine, based at least in part on the one or more categories, an inversion algorithm of a plurality of inversion algorithms; and instructions to determine, using the inversion algorithm of the plurality of inversion algorithms, one or more estimates of subsurface conditions.

Implementation 16: The one or more non-transitory computer-readable mediums of claim 15, the instructions further including instructions to train a machine learning module on a set of training data, wherein the training data comprises at least a set of previously categorized tube wave signals, wherein said instructions to determine one or more categories associated with the tube wave signal are included in the machine learning module.

Implementation 17: The one or more non-transitory computer-readable mediums according to any of the preceding Implementations, wherein the training data further comprises at least one of operational parameters, wellbore design parameters, or completion parameters.

Implementation 18: The one or more non-transitory computer-readable mediums according to any of the preceding Implementations, the instructions further including instructions to train a machine learning module on a set of training data, wherein the training data comprises a set of combinations, the combinations comprising one or more categories associated with a categorized tube wave signal, an indication of an inversion algorithm of the plurality of inversion algorithms, and an indication of a performance of the inversion algorithm on the categorized tube wave signal, wherein the instructions to determine the inversion algorithm of the plurality of inversion algorithms are included in the machine learning module.

Implementation 19: The one or more non-transitory computer-readable

mediums according to any of the preceding Implementations, wherein the training data further comprises at least one of operational parameters, wellbore design parameters, or completion parameters.

Implementation 20: The one or more non-transitory computer-readable mediums according to any of the preceding Implementations, the instructions further comprising: instructions to determine that at least one category of the one or more categories is in a predefined set of categories; and instructions to generate, in response to a determination that at least one category of the one or more categories is in the predefined set of categories, an indication of a subsurface condition.

1. A method for determining subsurface conditions in a wellbore, the method comprising:
receiving a tube wave signal corresponding to a tube wave within the wellbore;
determining one or more categories associated with the tube wave signal;
determining, based at least in part on the one or more categories, an inversion algorithm of a plurality of inversion algorithms; and
determining, using the inversion algorithm of the plurality of inversion algorithms, one or more estimates of subsurface conditions.

2. The method of claim 1, further comprising training a machine learning module on a set of training data, wherein the training data comprises at least a set of previously categorized tube wave signals, wherein said determining the one or more categories associated with the tube wave signal is performed by the machine learning module.

3. The method of claim 2, wherein the training data further comprises at least one of operational parameters, wellbore design parameters, or completion parameters.

4. The method of claim 2, further comprising generating the set of previously categorized tube wave signals using a classifier module.

5. The method of claim 1, further comprising training a machine learning module on a set of training data, wherein the training data comprises a set of combinations, the combinations comprising one or more categories associated with a categorized tube wave signal, an indication of an inversion algorithm of the plurality of inversion algorithms, and an indication of a performance of the inversion algorithm on the categorized tube wave signal, wherein said determining the inversion algorithm of the plurality of inversion algorithms is performed by the machine learning module.

6. The method of claim 5, wherein the training data further comprises at least one of operational parameters, wellbore design parameters, or completion parameters.

7. The method of claim 1, further comprising:
determining that at least one category of the one or more categories is in a predefined set of categories; and
in response to said determining that the at least one category of the one or more categories is in the predefined set of categories, generate an indication of a subsurface condition.

8. The method of claim 1, further comprising:
generating the tube wave in the wellbore; and
transforming the tube wave into the tube wave signal.

9. A well system comprising:
a computing system comprising:
one or more processors; and
one or more non-transitory computer-readable mediums including instructions which, when executed by the one or more processors, cause the one or more processors to determine subsurface conditions in a wellbore, the instructions including:
instructions to receive a tube wave signal corresponding to a tube wave within the wellbore;
instructions to determine one or more categories associated with the tube wave signal;
instructions to determine, based at least in part on the one or more categories, an inversion algorithm of a plurality of inversion algorithms; and
instructions to determine, using the inversion algorithm of the plurality of inversion algorithms, one or more estimates of subsurface conditions.

10. The well system of claim 9, the instructions further including instructions to train a machine learning module on a set of training data, wherein the training data comprises at least a set of previously categorized tube wave signals, wherein said instructions to determine one or more categories associated with the tube wave signal are included in the machine learning module.

11. The well system of claim 10, wherein the training data further comprises at least one of operational parameters, wellbore design parameters, or completion parameters.

12. The well system of claim 9, the instructions further including instructions to train a machine learning module on a set of training data, wherein the training data comprises a set of combinations, the combinations comprising one or more categories associated with a categorized tube wave signal, an indication of an inversion algorithm of the plurality of inversion algorithms, and an indication of a performance of the inversion algorithm on the categorized tube wave signal, wherein the instructions to determine the inversion algorithm of the plurality of inversion algorithms are included in the machine learning module.

13. The well system of claim 12, wherein the training data further comprises at least one of operational parameters, wellbore design parameters, or completion parameters.

14. The well system of claim 9, further comprising:
a pressure excitation device configured to generate the tube wave in the well system; and
a device communicatively coupled with the computing system, the device configured to transform the tube wave into the tube wave signal and transmit the tube wave signal to the computing system.

15. One or more non-transitory computer-readable mediums including instructions which, when executed by a processor, cause the processor to determine subsurface conditions in a wellbore, the instructions comprising:
instructions to receive a tube wave signal corresponding to a tube wave within the wellbore;
instructions to determine one or more categories associated with the tube wave signal;
instructions to determine, based at least in part on the one or more categories, an inversion algorithm of a plurality of inversion algorithms; and
instructions to determine, using the inversion algorithm of the plurality of inversion algorithms, one or more estimates of subsurface conditions.

16. The one or more non-transitory computer-readable mediums of claim 15, the instructions further including instructions to train a machine learning module on a set of training data, wherein the training data comprises at least a set of previously categorized tube wave signals, wherein said instructions to determine one or more categories associated with the tube wave signal are included in the machine learning module.

17. The one or more non-transitory computer-readable mediums of claim 16, wherein the training data further comprises at least one of operational parameters, wellbore design parameters, or completion parameters.

18. The one or more non-transitory computer-readable mediums of claim 15, the instructions further including instructions to train a machine learning module on a set of training data, wherein the training data comprises a set of combinations, the combinations comprising one or more categories associated with a categorized tube wave signal, an indication of an inversion algorithm of the plurality of inversion algorithms, and an indication of a performance of the inversion algorithm on the categorized tube wave signal, wherein the instructions to determine the inversion algorithm of the plurality of inversion algorithms are included in the machine learning module.

19. The one or more non-transitory computer-readable mediums of claim 18, wherein the training data further comprises at least one of operational parameters, wellbore design parameters, or completion parameters.

20. The one or more non-transitory computer-readable mediums of claim 15, the instructions further comprising:
instructions to determine that at least one category of the one or more categories is in a predefined set of categories; and
instructions to generate, in response to a determination that at least one category of the one or more categories is in the predefined set of categories, an indication of a subsurface condition.
